(19) United States
(12) Patent Application Publication
(10) Pub. No.: US 2026/0302683 A1
(43) Pub. Date: Oct. 1, 2026

(54) CONNECTOR

(71) Applicant: Yazaki Corporation, Tokyo (JP)

(72) Inventors: Satoshi Nakai, Shizuoka (JP); Takeo Ida, Shizuoka (JP)

(21) Appl. No.: 19/565,697

(22) Filed: Mar. 13, 2026

(30) Foreign Application Priority Data
Mar. 31, 2025 (JP) 2025-057716

(51) Int. Cl. H01R 13/52; H01R 13/512; H01R 13/74

(52) U.S. Cl. CPC H01R 13/5202; H01R 13/512; H01R 13/748

(57) ABSTRACT

An annular seal member includes an annular seal main body and at least one positioning protrusion, in which the positioning protrusion includes a first protruding portion protruding from the seal main body toward an axial center of the seal main body in a direction orthogonal to an annular axis of the seal main body, a second protruding portion protruding to one side in a circumferential direction of the seal main body from a tip on a protruding direction side of the first protruding portion, and a third protruding portion protruding to the other side in the circumferential direction of the seal main body from the tip of the first protruding portion, and the fitting portion has a locking groove provided in a tip on an insertion-and-fitting direction side and inside a ring of the fitting portion and configured for the positioning protrusion to be fitted thereinto and locked therein.

### CROSS-REFERENCE TO RELATED APPLICATION(S)

The present application claims priority to and incorporates by reference the entire contents of Japanese Patent Application No. 2025-057716 filed in Japan on Mar. 31, 2025.

### BACKGROUND OF THE INVENTION

### 1. Field of the Invention

The present invention relates to a connector.

### 2. Description of the Related Art

Conventionally, a connector is provided with an annular seal member such as a packing that fills a gap with a mating component after fitting connection and suppresses infiltration of liquid and dust from the gap. The seal member is assembled with an outer peripheral surface of an annular fitting portion in a housing, and fills a gap between the outer peripheral surface and an annular inner peripheral surface of the mating component. In this connector, positioning of the seal member with respect to the housing and holding of the seal member at the position are achieved by locking a positioning protrusion of the seal member to the housing. For example, such a connector is disclosed in JP 2013-140 821 A.

In this type of connector, in order to secure a positioning function and a holding function of the seal member with respect to the housing, it is necessary to suppress excessive deformation of the positioning protrusion when load is applied to the positioning protrusion. Conventional connectors have room for improvement in this respect.

### SUMMARY OF THE INVENTION

Therefore, an object of the present invention is to provide a connector capable of securing a positioning function and a holding function of a seal member.

In order to achieve the above mentioned object, a connector according to one aspect of the present invention includes a terminal fitting; a housing including a terminal accommodating portion and an annular fitting portion, the terminal accommodating portion being configured to accommodate the terminal fitting therein, the fitting portion being inserted and fitted into and connected to a mating fitting hole in an insertion-and-fitting direction; and an annular seal member assembled with an outer peripheral surface of the fitting portion, wherein the seal member includes an annular seal main body disposed concentrically on the outer peripheral surface of the fitting portion, the seal main body filling an annular gap between the outer peripheral surface of the fitting portion and an inner peripheral surface of the fitting hole, and at least one positioning protrusion protruding from the seal main body toward an inner side of a ring of the seal main body, the positioning protrusion includes a first protruding portion protruding from the seal main body toward an axial center of the seal main body in a direction orthogonal to an annular axis of the seal main body, a second protruding portion protruding to one side in a circumferential direction of the seal main body from a tip on a protruding direction side of the first protruding portion, and a third protruding portion protruding to the other side in the circumferential direction of the seal main body from the tip of the first protruding portion, and the fitting portion has a locking groove provided in a tip on the insertion-and-fitting direction side and on an inner side of a ring of the fitting portion, the locking groove being configured for the positioning protrusion to be fitted thereinto and locked therein.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an outline of a connector according to an embodiment;

FIG. 2 is an exploded perspective view illustrating an outline of the connector according to the embodiment;

FIG. 3 is a plan view illustrating a main part of the connector according to the embodiment;

FIG. 4 is a perspective view illustrating the main part of the connector according to the embodiment;

FIG. 5 is a perspective view illustrating a main part of a seal member;

FIG. 6 is a plan view illustrating a main part of a housing; and

FIG. 7 is a perspective view illustrating the main part of the housing.

### DETAILED DESCRIPTION OF THE PREFERRED EMBODIMENTS

Hereinafter, an embodiment of a connector according to the present invention will be described in detail with reference to the drawings. Note that the present invention is not limited by the embodiment.

### Embodiment

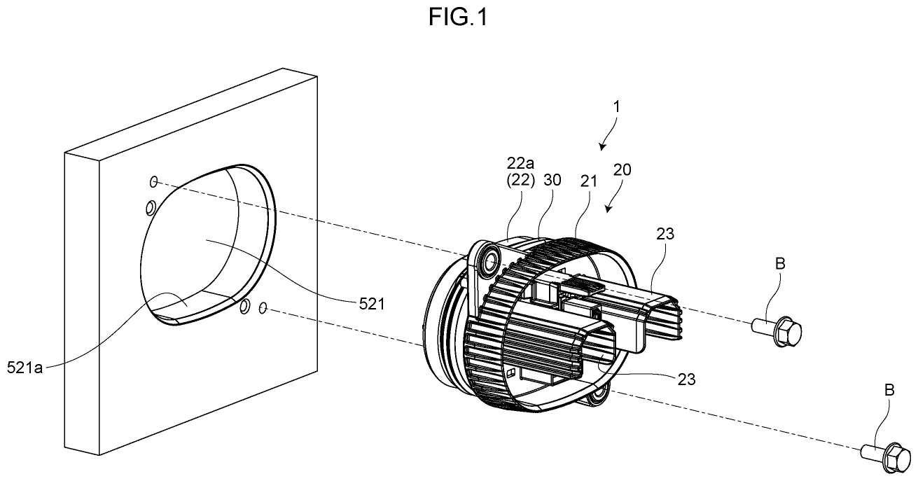

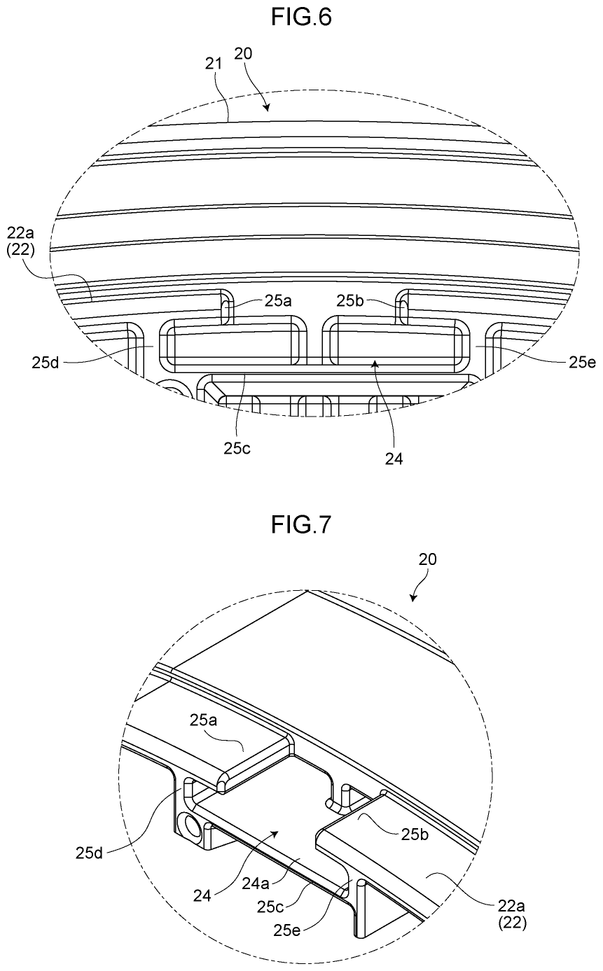

One embodiment of a connector according to the present invention will be described with reference to FIGS. 1 to 7.

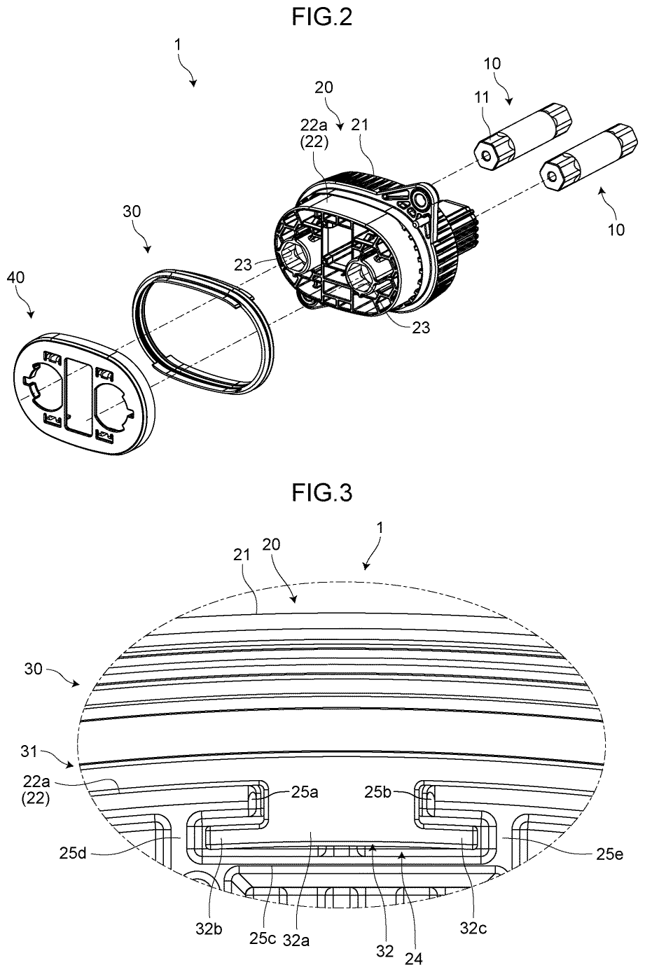

Reference numeral 1 in FIGS. 1 and 2 denotes the connector according to the present embodiment. The connector 1 is inserted and fitted into a mating fitting hole 521 having an inner peripheral surface 521a, and is electrically connected to a mating terminal fitting (not illustrated) (in FIG. 1). The fitting hole 521 is, for example, a through hole formed in a wall body of a housing of an electric device including the mating terminal fitting. The fitting hole 521 is, for example, an internal space of an annular mating fitting portion in a mating housing in a mating connector including a mating terminal fitting.

The connector 1 includes a terminal fitting 10, a housing 20, and a seal member 30 (FIGS. 1 and 2).

The terminal fitting 10 is formed of a conductive material such as metal. For example, the terminal fitting 10 may have either a male terminal portion or a female terminal portion, and may be fitted and connected to a mating terminal fitting having the other terminal portion therein. The terminal fitting 10 may be screwed and fixed to the mating terminal fitting. The terminal fitting 10 illustrated here is formed in a shaft shape, and a bolt fixing portion 11 for coaxially fixing a stud bolt (not illustrated) is formed at an end portion thereof (FIG. 2).

The housing 20 is formed of an insulating material such as a synthetic resin. The housing 20 is provided with an annular housing main body 21 and an annular fitting portion 22 coaxially protruding from the housing main body 21 (FIGS. 1 and 2). In the housing 20, a terminal accommodating portion 23 that accommodates and holds the terminal fitting 10 therein is provided inside the housing main body 21 and the fitting portion 22 for each terminal fitting 10 (FIGS. 1 and 2). For example, a part or an entirety of the terminal accommodating portion 23 is formed in a tubular shape having a tubular axis parallel to an annular axis of the fitting portion 22, and accommodates and holds the terminal fitting 10 in a tube thereof. The housing 20 is fixed to a peripheral edge portion of the fitting hole 521 using a bolt B (FIG. 1).

An outer peripheral surface 22a of the fitting portion 22 is formed in a shape similar to the inner peripheral surface 521a of the mating fitting hole 521, and is inserted and fitted into and connected to the fitting hole 521 in an insertion-and-fitting direction (FIG. 1). Therefore, the fitting hole 521 and the fitting portion 22 concentrically inserted and fitted into the fitting hole 521 form an annular gap between the outer peripheral surface 22a and the inner peripheral surface 521a. The seal member 30 is formed in an annular shape to fill the gap and is assembled with the outer peripheral surface 22a of the fitting portion 22. The seal member 30 is formed of an elastically deformable synthetic resin material such as synthetic rubber.

The seal member 30 includes an annular seal main body 31 that is disposed concentrically with the outer peripheral surface 22a of the fitting portion 22 and fills the annular gap between the outer peripheral surface 22a of the fitting portion 22 and the inner peripheral surface 521a of the fitting hole 521 (FIGS. 3 to 5). For example, the seal main body 31 is provided with a plurality of annular first lips in concentrically close contact with the outer peripheral surface 22a of the fitting portion 22 and a plurality of annular second lips in concentrically close contact with the inner peripheral surface 521a of the fitting hole 521.

In addition, the seal member 30 has at least one positioning protrusion 32 protruding from the seal main body 31 toward an inner side of a ring of the seal main body 31 (FIGS. 3 to 5). For example, the seal member 30 is provided with positioning protrusions 32 at two positions with an axial center of the seal main body 31 interposed therebetween.

The positioning protrusion 32 includes a first protruding portion 32a protruding from the seal main body 31 toward the axial center of the seal main body 31 in a direction orthogonal to an annular axis of the seal main body 31, a second protruding portion 32b protruding to one side in a circumferential direction of the seal main body 31 from a tip on the protruding direction side of the first protruding portion 32a, and a third protruding portion 32c protruding to the other side in the circumferential direction of the seal main body 31 from the tip of the first protruding portion 32a (FIGS. 3 to 5). The positioning protrusion 32 is formed in a T shape having the first protruding portion 32a, the second protruding portion 32b, and the third protruding portion 32c. The positioning protrusion 32 is formed in a flat plate shape having a plane orthogonal to the annular axis of the seal main body 31.

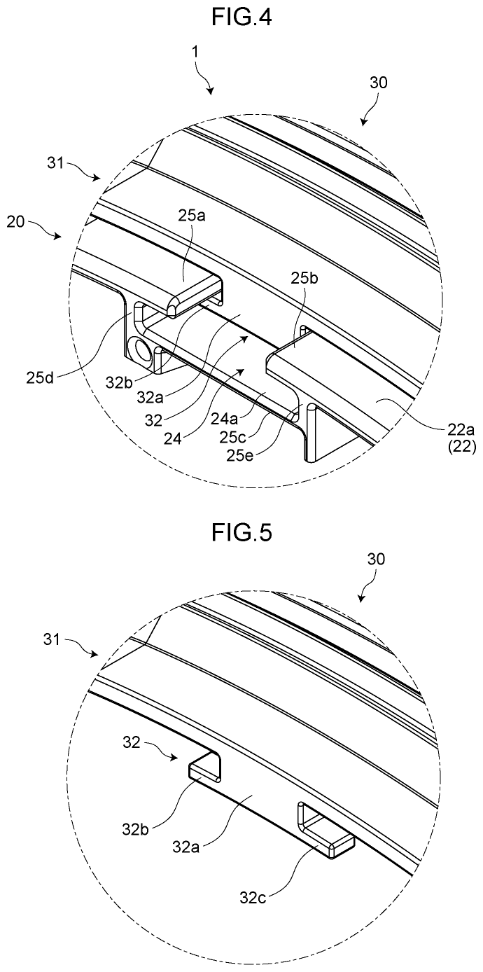

The fitting portion 22 has a locking groove 24 provided in a tip thereof and on the inner side of a ring thereof on the insertion-and-fitting direction side with respect to the fitting hole 521 and configured for the positioning protrusion 32 to be fitted thereinto and locked therein (FIGS. 3, 4, 6, and 7). The locking groove 24 allows the positioning protrusion 32 to be fitted thereinto and locked in a peripheral edge portion thereof, thereby suppressing positional deviation of the positioning protrusion 32 in the circumferential direction of the seal main body 31 with respect to the outer peripheral surface 22a of the fitting portion 22 and suppressing positional deviation of the positioning protrusion 32 in a direction orthogonal to the annular axis of the seal main body 31 with respect to the outer peripheral surface 22a of the fitting portion 22. When the seal member 30 is assembled with the outer peripheral surface 22a of the fitting portion 22, the positioning protrusion 32 is inserted from an opening 24a of the locking groove 24 in an annular axis direction of the seal main body 31 (FIGS. 4 and 7).

The peripheral edge portion of the locking groove 24 is provided with a first locking portion 25a that locks the first protruding portion 32a from one side in the circumferential direction of the seal main body 31 and locks the second protruding portion 32b from a side opposite to the axial center of the seal main body 31, and a second locking portion 25b that locks the first protruding portion 32a from the other side in the circumferential direction of the seal main body 31 and locks the third protruding portion 32c from the side opposite to the axial center of the seal main body 31 (FIGS. 3, 4, 6, and 7).

The locking groove 24 suppresses positional deviation of the positioning protrusion 32 to one side in the circumferential direction of the seal main body 31 with respect to the outer peripheral surface 22a of the fitting portion 22 by locking the first protruding portion 32a to the first locking portion 25a. In addition, the locking groove 24 suppresses positional deviation of the positioning protrusion 32 to the other side in the circumferential direction of the seal main body 31 with respect to the outer peripheral surface 22a of the fitting portion 22 by locking the first protruding portion 32a to the second locking portion 25b. In addition, the locking groove 24 locks the second protruding portion 32b to the first locking portion 25a and locks the third protruding portion 32c to the second locking portion 25b, thereby suppressing positional deviation of the positioning protrusion 32 to the side opposite to the axial center of the seal main body 31 with respect to the outer peripheral surface 22a of the fitting portion 22.

Further, the locking groove 24 has a third locking portion 25c provided at the peripheral edge portion thereof and adapted to lock the first protruding portion 32a, the second protruding portion 32b, and the third protruding portion 32c from the axial center side of the seal main body 31 (FIGS. 3, 4, 6, and 7).

The locking groove 24 locks the first protruding portion 32a, the second protruding portion 32b, and the third protruding portion 32c to the third locking portion 25c from the axial center side, thereby suppressing positional deviation of the positioning protrusion 32 toward the axial center side of the seal main body 31 with respect to the outer peripheral surface 22a of the fitting portion 22.

Further, the locking groove 24 has a fourth locking portion 25d provided at the peripheral edge portion thereof and adapted to lock the second protruding portion 32b from one side in the circumferential direction of the seal main body 31 and has a fifth locking portion 25e provided at the peripheral edge portion thereof and adapted to lock the third protruding portion 32c from the other side in the circumferential direction of the seal main body 31 (FIGS. 3, 4, 6, and 7).

The locking groove 24 suppresses positional deviation of the positioning protrusion 32 to one side in the circumferential direction of the seal main body 31 with respect to the outer peripheral surface 22a of the fitting portion 22 by locking the second protruding portion 32b to the fourth locking portion 25d. In addition, the locking groove 24 suppresses positional deviation of the positioning protrusion 32 to the other side in the circumferential direction of the seal main body 31 with respect to the outer peripheral surface 22a of the fitting portion 22 by locking the third protruding portion 32c to the fifth locking portion 25e.

The locking groove 24 illustrated here is formed in a T-shaped groove shape having the first protruding portion 32a, the second protruding portion 32b, the third protruding portion 32c, the fourth locking portion 25d, and the fifth locking portion 25e at the peripheral edge portion thereof.

In this manner, the positioning protrusion 32 is disposed on the inner side of the ring of the seal main body 31, and the movement of the seal main body 31 in the circumferential direction or the direction orthogonal to the annular axis of the seal main body 31 is locked in the groove of the locking groove 24 disposed on the inner side of the ring of the fitting portion 22. Therefore, the positioning protrusion 32 is hardly affected by force acting on the seal main body 31 when the fitting portion 22 is inserted and fitted into and connected to the fitting hole 521, and can be inserted into the groove of the locking groove 24 without large deformation of the positioning protrusion 32. Therefore, in the connector 1 of the present embodiment, since the positioning protrusion 32 can be fixed in the groove of the locking groove 24 without large deformation of the positioning protrusion 32, a positioning function and a holding function of the seal member 30 with respect to the fitting portion 22 can be exhibited by the locking groove 24 and the positioning protrusion 32.

Further, the positioning protrusion 32 is formed in a flat plate shape having a plane orthogonal to the annular axis of the seal main body 31, but is locked in the locking groove 24 not in a bending direction (in other words, a bending direction of the seal main body 31 in the annular axis direction) in which the deformation amount is large but in a compression direction or a tensile direction (in other words, the direction orthogonal to the annular axis of the seal main body 31) in which the deformation amount is small. Therefore, for example, when the fitting portion 22 is inserted and fitted into and connected to the fitting hole 521, even if external force in the circumferential direction of the seal main body 31 or the direction orthogonal to the annular axis of the seal main body 31 is applied via the seal main body 31, the positioning protrusion 32 can receive the external force in the compression direction or the tensile direction having a small deformation amount. Therefore, in the connector 1 of the present embodiment, since the positioning protrusion 32 can be fixed in the groove of the locking groove 24 without large deformation of the positioning protrusion 32 from this point as well, it is possible to exhibit a positioning function and a holding function of the seal member 30 with respect to the fitting portion 22.

Here, desirably, a groove depth of the locking groove 24 from the opening 24a in the insertion direction of the positioning protrusion 32 is formed to be deeper than the thickness of the positioning protrusion 32 in the annular axis direction of the seal main body 31 (here, plate thickness of the positioning protrusion 32). The groove depth of the locking groove 24 is set to a size that prevents the positioning protrusion 32 from protruding from the groove of the locking groove 24 even if the positioning protrusion 32 is bent in the bending direction (in other words, the annular axis direction of the seal main body 31). Accordingly, even if the positioning protrusion 32 is bent toward the opening 24a, the locking groove 24 can fix the positioning protrusion 32 in the groove. Therefore, even if the positioning protrusion 32 is bent toward the opening 24a in the groove of the locking groove 24, when external force in the circumferential direction of the seal main body 31 or the direction orthogonal to the annular axis of the seal main body 31 is applied, the positioning protrusion 32 can receive the external force in the compression direction or the tensile direction having a small deformation amount. That is, in the connector 1 of the present embodiment, even if the positioning protrusion 32 is bent toward the opening 24a side in the groove of the locking groove 24, the positioning protrusion 32 can be fixed in the groove of the locking groove 24, so that the positioning function and the holding function of the seal member 30 with respect to the fitting portion 22 can be exhibited.

Note that the connector 1 exemplified here is provided with a front holder 40 to be assembled with a tip of the fitting portion 22 on the insertion-and-fitting direction side with respect to the fitting hole 521 (FIG. 2).

The positioning protrusion of the connector according to the present embodiment is disposed on the inner side of the ring of the seal main body, and the movement of the seal main body in the circumferential direction or the direction orthogonal to the annular axis of the seal main body is locked in the groove of the locking groove disposed on the inner side of the ring of the fitting portion. Therefore, the positioning protrusion is hardly affected by force acting on the seal main body when the fitting portion is inserted and fitted into and connected to the fitting hole, and can be inserted into the groove of the locking groove without large deformation of the positioning protrusion. Therefore, in the connector according to the present embodiment, since the positioning protrusion can be fixed in the groove of the locking groove without large deformation of the positioning protrusion, a positioning function and a holding function of the seal member with respect to the fitting portion can be exhibited by the locking groove and the positioning protrusion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminal fitting;
a housing including a terminal accommodating portion and an annular fitting portion, the terminal accommodating portion being configured to accommodate the terminal fitting therein, the fitting portion being inserted and fitted into and connected to a mating fitting hole in an insertion-and-fitting direction; and
an annular seal member assembled with an outer peripheral surface of the fitting portion, wherein
the seal member includes an annular seal main body disposed concentrically on the outer peripheral surface of the fitting portion, the seal main body filling an annular gap between the outer peripheral surface of the fitting portion and an inner peripheral surface of the fitting hole, and at least one positioning protrusion protruding from the seal main body toward an inner side of a ring of the seal main body,
the positioning protrusion includes a first protruding portion protruding from the seal main body toward an axial center of the seal main body in a direction orthogonal to an annular axis of the seal main body, a second protruding portion protruding to one side in a circumferential direction of the seal main body from a tip on a protruding direction side of the first protruding portion, and a third protruding portion protruding to the other side in the circumferential direction of the seal main body from the tip of the first protruding portion, and
the fitting portion has a locking groove provided in a tip on the insertion-and-fitting direction side and on an inner side of a ring of the fitting portion, the locking groove being configured for the positioning protrusion to be fitted thereinto and locked therein.

2. The connector according to claim 1, wherein the positioning protrusion is formed to have a T shape including the first protruding portion, the second protruding portion, and the third protruding portion.

3. The connector according to claim 2, wherein the positioning protrusion is formed to have a flat plate shape including a plane orthogonal to the annular axis of the seal main body.

4. The connector according to claim 1, wherein the locking groove has a first locking portion, a second locking portion, and a third locking portion each provided at a peripheral edge portion thereof, the first locking portion locking the first protruding portion from one side in the circumferential direction of the seal main body and locking the second protruding portion from a side opposite to the axial center of the seal main body, the second locking portion locking the first protruding portion from the other side in the circumferential direction of the seal main body and locking the third protruding portion from the side opposite to the axial center of the seal main body, the third locking portion locking the first protruding portion, the second protruding portion, and the third protruding portion from the axial center side of the seal main body.

5. The connector according to claim 2, wherein the locking groove has a first locking portion, a second locking portion, and a third locking portion each provided at a peripheral edge portion thereof, the first locking portion locking the first protruding portion from one side in the circumferential direction of the seal main body and locking the second protruding portion from a side opposite to the axial center of the seal main body, the second locking portion locking the first protruding portion from the other side in the circumferential direction of the seal main body and locking the third protruding portion from the side opposite to the axial center of the seal main body, the third locking portion locking the first protruding portion, the second protruding portion, and the third protruding portion from the axial center side of the seal main body.

6. The connector according to claim 3, wherein the locking groove has a first locking portion, a second locking portion, and a third locking portion each provided at a peripheral edge portion thereof, the first locking portion locking the first protruding portion from one side in the circumferential direction of the seal main body and locking the second protruding portion from a side opposite to the axial center of the seal main body, the second locking portion locking the first protruding portion from the other side in the circumferential direction of the seal main body and locking the third protruding portion from the side opposite to the axial center of the seal main body, the third locking portion locking the first protruding portion, the second protruding portion, and the third protruding portion from the axial center side of the seal main body.

7. The connector according to claim 4, wherein the locking groove is formed in a T-shaped groove shape having, at the peripheral edge portion thereof, the first locking portion, the second locking portion, the third locking portion, a fourth locking portion adapted to lock the second protruding portion from the one side in the circumferential direction of the seal main body, and a fifth locking portion adapted to lock the third protruding portion from the other side in the circumferential direction of the seal main body.

8. The connector according to claim 5, wherein the locking groove is formed in a T-shaped groove shape having, at the peripheral edge portion thereof, the first locking portion, the second locking portion, the third locking portion, a fourth locking portion adapted to lock the second protruding portion from the one side in the circumferential direction of the seal main body, and a fifth locking portion adapted to lock the third protruding portion from the other side in the circumferential direction of the seal main body.

9. The connector according to claim 6, wherein the locking groove is formed in a T-shaped groove shape having, at the peripheral edge portion thereof, the first locking portion, the second locking portion, the third locking portion, a fourth locking portion adapted to lock the second protruding portion from the one side in the circumferential direction of the seal main body, and a fifth locking portion adapted to lock the third protruding portion from the other side in the circumferential direction of the seal main body.

10. The connector according to claim 1, wherein
the positioning protrusion is inserted from an opening in the locking groove in an annular axis direction of the seal main body, and
the locking groove has a groove depth in an insertion direction of the positioning protrusion from the opening, the groove depth being formed to be deeper than a thickness of the positioning protrusion in the annular axis direction of the seal main body.

11. The connector according to claim 2, wherein
the positioning protrusion is inserted from an opening in the locking groove in an annular axis direction of the seal main body, and
the locking groove has a groove depth in an insertion direction of the positioning protrusion from the opening, the groove depth being formed to be deeper than a thickness of the positioning protrusion in the annular axis direction of the seal main body.

12. The connector according to claim 3, wherein
the positioning protrusion is inserted from an opening in the locking groove in an annular axis direction of the seal main body, and
the locking groove has a groove depth in an insertion direction of the positioning protrusion from the opening, the groove depth being formed to be deeper than a thickness of the positioning protrusion in the annular axis direction of the seal main body.
